(19) United States
(12) Patent Application Publication
(10) Pub. No.: US 2005/0238465 A1
(43) Pub. Date: Oct. 27, 2005

(54) Robotic retail facility

(76) Inventor: Sergey N. Razumov, Moscow (RU)

Correspondence Address: McDERMOTT, WILL & EMERY, 600 13th Street, N.W., Washington, DC, 20005-3096, US

(21) Appl. No.: 10/832,383

(22) Filed: Apr. 27, 2004

(51) Int. Cl. B65G 1/00

(52) U.S. Cl. 414/273

(57) ABSTRACT

A novel robotic system for selling goods at a retail facility having a storage area not accessible by customers. The system includes a plurality of movable robots, and a control system. When a customer orders a purchase composed of multiple items, the control system assigns at least one robot to that customer to pick up the multiple items of the purchase in the storage area. The robot delivers the purchase directly to the customer or to a delivery area.

### FIELD OF THE INVENTION

The present invention relates to a retail system, and, more particular, to a system for selling goods utilizing movable robots for picking up and delivery goods requested by customers.

### BACKGROUND OF THE INVENTION

Robots in retail facilities may interact with customers to perform such tasks as advertising, marketing, customer relations, maintenance and monitoring of the retail environment, etc. For example, U.S. Pat. No. 6,584,375 discloses robots in a traditional retail environment. Each of the robots includes a processor portion for processing retail data, a memory portion, an interaction portion for interfacing with a customer by receiving an input from the customer and generating an output responsive to the input, and a transport portion for transporting the robot to various locations. Based on inputs from customers, the robots may provide customers with shopping lists and information as to locations of particular articles on the shelves of the store, serve as a mobile advertising and marketing kiosk and as an automated teller machine (ATM) for providing the customers with requested money, etc. Hence, known robotic retail systems are utilized to facilitate shopping in traditional supermarkets having shelves stocked with goods accessible to customers.

However, it is well known that the most expensive place to hold merchandise is on the shelf of a retail store because of all resources it consumes, such as storage costs and labor. In addition, due to limited capacities of stores, the assortment of goods that they offer on their shelves is narrow. For example, consumer study conducted by Anderson Consulting (now Accenture) and the Food Marketing Institute (FMI) showed that of the products consumers want in a grocery store, 6% to 8% are out-of-stock. For promotional items, this number jumps to 25% out-of-stock products. The study concluded that the out-of-stock levels add up to about $100 billion in lost sales for retailers.

Therefore, there is a need for a robotic system for selling goods that would enable retailers to meet customers' demands without having to hold goods on the shelves accessible to customers.

### SUMMARY OF THE INVENTION

The present application provides a novel robotic system for selling goods at a retail facility having a storage area not accessible to customers. The system includes a plurality of movable robots, and a control system. When a customer orders a purchase composed of multiple items, the control system assigns at least one robot to that customer to pick up the multiple items of the purchase in the storage area. The robot may deliver the purchase directly to the customer or to a delivery area.

In accordance with one aspect of the invention, the control system may control the robot to pick up the first item of the multiple items requested by the customer, only after the customer requests a determined number of the items. Each robot has a holding area for holding the items being picked up. The control system may determine whether the holding area will be sufficiently loaded with the items being requested by customer, in order to instruct the robot to start picking up the requested items only when the holding area will be sufficiently loaded or the number of the requested items is less than the maximum number of items that may be placed at the holding area.

In accordance with an embodiment of the invention, the control system may virtually place the requested items at the holding area of the robot to produce a virtual layout of the items at the holding area. The robot is controlled to start picking up the items requested by the customer only when the virtual layout indicates that the number of items requested by the customer is sufficient to load the holding area of the robot, or the number of the requested items is less than the maximum number of items that may be placed at the holding area.

In accordance with another aspect of the invention, the control system may determine an optimal route for the robot to pick up the multiple items requested by the customer. The route may be optimized so as to minimize time required for picking up the multiple items taking into account a need to avoid possible interferences or collisions between the robots.

A task of performing the customer's request may be assigned to a robot positioned closer to a storage cell that stores an initial item to be picked up. After the robot finishes the current task, it may receive a next task. If no new task is available, the robot may be placed into a waiting point for receiving a next assignment. The waiting point may be selected so as maintain a predetermined distribution of the robots in the storage area. For example, the predetermined distribution of the robots in various regions of the storage area may be maintained in accordance with an anticipated frequency of robot's access to the respective regions.

In accordance with a further aspect of the invention, the storage area may contain multiple storage sections for storing different types of goods. For example, the storage sections may maintain different conditions required for storing goods. To avoid interaction of items that should not be transported together, for example, frozen products such as meat and dry products such as salt, separate robots may be assigned to different storage sections. When items requited by a customer include items stored in different storage section, the control system controls the robots assigned to the respective sections to pick up these items.

In accordance with another aspect of the invention, the storage structure may have a plurality of storage levels for storing goods. Longitudinal and transverse passes are provided for enabling the robots to access the stored goods within each level. Vertical and inclined passes may enable the robots to move between the levels.

In accordance with an embodiment of the invention, the control system is responsive to a request from the customer for an item stored on a predetermined level by assigning a robot available on the predetermined level to pick up the item. If no robots are available on the predetermined level, an available robot located on a level closest to the predetermined level may be assigned. For example, the control system may determine the highest storage level that stores an item of the multiple items of the purchase, and assign a robot available on the highest storage level or close to the highest level to pick up the multiple requested items. The assigned robot may be controlled to move from a higher level of the storage structure to a lower level of the structure during collection of the requested items.

Still other objects and advantages of the present invention will become readily apparent from the following detailed description, simply by way of illustration of the best mode contemplated of carrying out the invention. As will be realized, the invention is capable of other and different embodiments, and its several details are capable of modifications in various obvious respects, all without departing from the invention. Accordingly, the drawing and description are to be regarded as illustrative in nature, and not as restrictive.

### BRIEF DESCRIPTION OF THE DRAWINGS

FIG. 1 is a diagram schematically illustrating an exemplary retail facility of the present invention.

FIG. 2 is a schematic plan view of an exemplary storage arrangement of the present invention.

FIGS. 3A, 3B and 3C schematically show cross-sections of the multi-level storage arrangement with exemplary inclined passes having inclination angles 30, 11, and 20 degrees, respectively.

FIG. 4 is a block diagram illustrating an exemplary robot of the present invention.

FIG. 5 is a flow chart illustrating a robot control procedure of the present invention.

### DESCRIPTION OF THE INVENTION

In the following description, for the purposes of explanation, numerous specific details are set forth in order to provide a thorough understanding of the present invention. It will be apparent, however, to one skilled in the art that the present invention may be practiced without these specific details. In other instances, well-known structures and entities are shown in block diagram form in order to avoid unnecessarily obscuring the present invention.

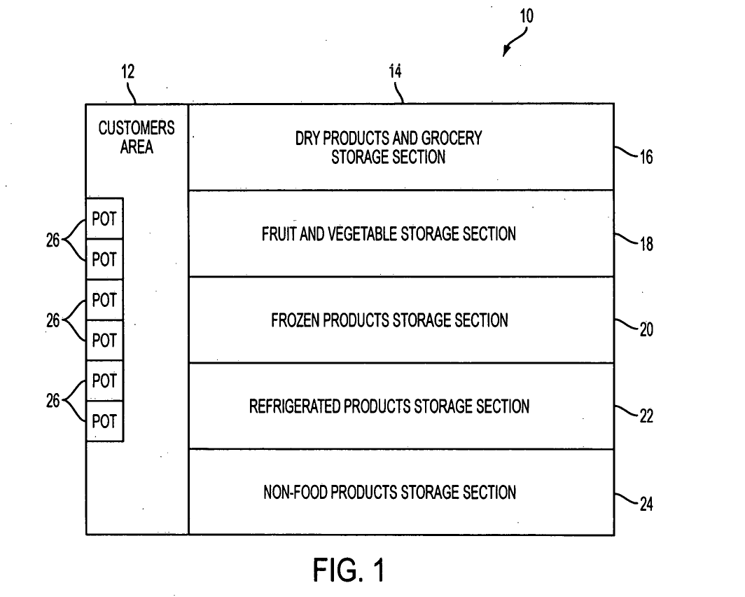

While the present application is disclosed with an example of a retail facility for selling food products, one skilled in the art would understand that the invention may be practiced in any facility where goods should be picked up in a storage area and delivered to customers. Referring to FIG. 1, a retail facility 10 of the present invention may include a customers area 12 arranged for enabling customers to request and receive goods being sold, and a storage area 14 for storing the goods. As disclosed in more detail below, the storage area may have multiple levels provided with stands having storage cells.

As schematically illustrated in FIG. 1, the storage area 14 may include multiple various storage sections for storing products at proper storage conditions, such as a dry products and grocery section 16 for storing dry food products and grocery, a fruit and vegetable section 18 for storing fruits and vegetables, a frozen products section 20 for storing food products purchased in a frozen state, a refrigerated products section 22 for storing perishable products in a refrigerated condition, and a non-food products section 24 for storing non-food consumer goods traditionally purchased in a grocery store. One skilled in the art would understand that the storage area 14 may contain any number of storage sections for storing various types of products. Although FIG. 1 shows multiple storage sections arranged on a single level of the storage area 14, one skilled in the art would understand that individual storage sections may be arbitrarily distributed within the storage area. For example, some storage sections may be arranged in multiple levels, whereas other sections may occupy only a single level of the storage area 14.

The customers area 12 may contain one or more purchase ordering terminals (POT) 26 for enabling customers to request available products for purchasing. The purchase ordering terminal may be a touch screen computer having a touch sensitive screen. The user may interface with the computer by appropriately touching areas of the display screen with the finger to execute commands, enter data, respond to prompts, etc. The purchase ordering terminal may have a user-friendly graphical user interface (GUI) that facilitates purchase ordering using a touch screen computer. This graphical user interface is disclosed in more detail in my copending U.S. patent application Ser. No. 10/354,025, filed on Jan. 30, 2003 and incorporated herewith by reference. Alternatively, customers may order products from remote locations using remote computers or telephones.

As described in more detail later, multiple robots are utilized for performing multiple tasks in connection with retail operations carried out in the retail facility 10. In particular, the robots may pick up and deliver from the respective storage sections products requested by the customers via the purchase ordering terminals 26 or from remote locations. Further, the robots may unload products delivered to the retail facility 10, place the unloaded products into respective storage cells of the storage area 14, and remove boxes, cases or other containers for holding products after the products are received by customers. Operations of the robots may be controlled by a local computer control system provided in a retail facility or by a central control system provided for controlling retail operations in multiple retail facilities.

By contrast with traditional supermarkets keeping products available for sale on shelves accessible to customers, the retail facility of the present invention holds available products in a multi-level storage area where the stored products are not accessible to customers. As a result, the storage area of the present invention may store substantially broader assortment of products than traditional supermarkets in a smaller storage space. Hence, customers' demands may be met without having to hold excessive quantity of goods on the shelves.

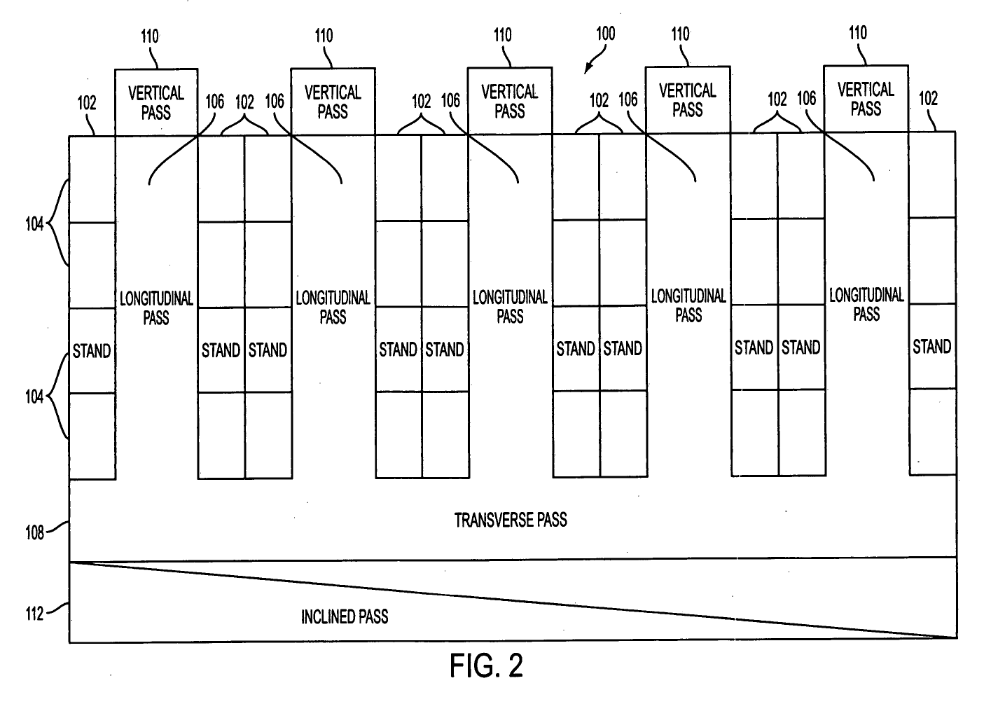

FIG. 2 is a schematic plan view of an exemplary multi-level storage arrangement 100 for storing goods in the retail facility of the present invention. This storage arrangement may represent one of the storage sections in the storage area 14. Alternatively, several storage sections may be provided within the storage arrangement 100.

As shown in FIG. 2, the storage arrangement comprises multiple storage stands 102, each having storage cells 104 which may be arranged in multiple rows and multiple columns for storing various articles available for sale. The articles may be held in boxes insertable into the respective storage cells. Each box may be divided to accommodate a number of smaller cases having various sizes for storing individual articles of respective sizes. For example, 2, 4, 8 or 16 cases may be inserted in a box to hold articles of various sizes. Also, an article may be stored directly in the box. As discussed in more detail below, robots may transport and deliver articles in the respective cases or boxes. Alternatively, a separate basket may be utilized to transport and deliver to a customer an article of a larger size. The basket may be transported separately or inside the box. One skilled in the art would understand that the present invention may be practiced in any other storage environments with any types and sizes of stands, storage cells, and storage containers for holding and transporting articles within the scope of the inventive concept.

Further, the storage arrangement 100 may contain longitudinal passes 106 arranged along the stands 102, and at least one transverse pass 108 arranged orthogonally with respect to the longitudinal passes 106. The passes 106 and 108 are arranged to enable each robot to access the storage cells 104 within each level of the multi-level storage arrangement.

Also, vertical passes 110 may be provided in the multi-layer storage arrangement 100 for enabling robots to move between levels of the multi-level storage arrangement 100. For example, the robots may be moved down and/or up through the vertical passes 110 using lifting devices such as elevators. Alternatively, the robot may be configured to go down and/or up through the vertical passes 110 without a separate lifting device but using a transportation mechanism of the robot.

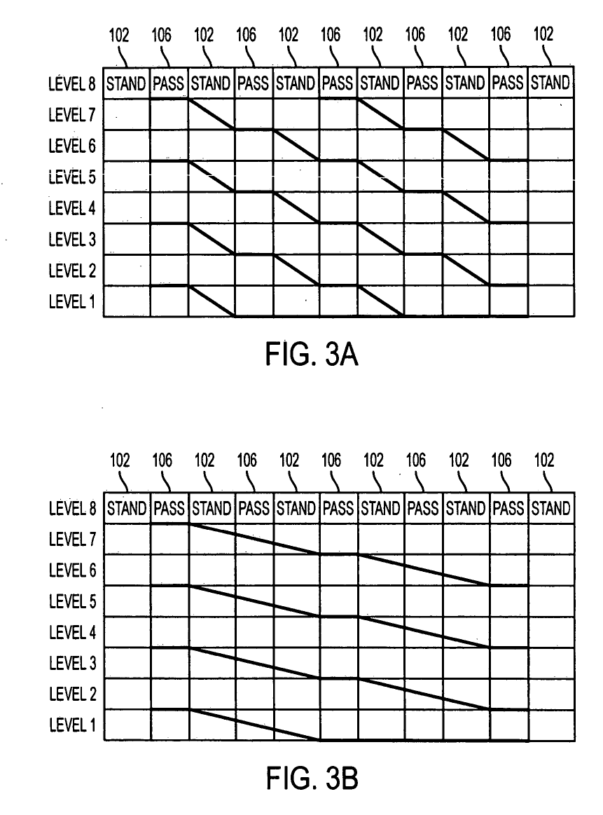

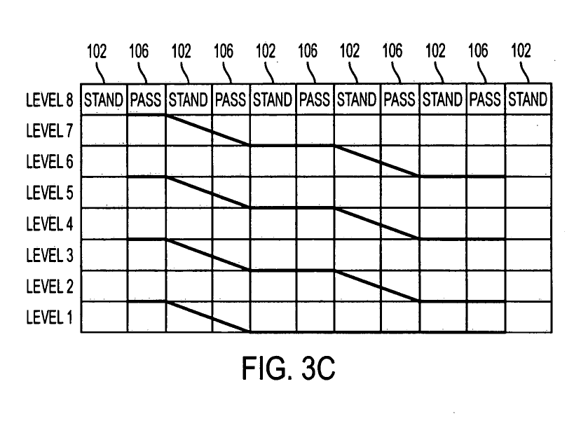

To enable robots to move down and/or up between levels, the storage arrangement 100 may also have inclined passes 112 provided between adjacent levels of the storage arrangement 100. FIGS. 3A, 3B and 3C schematically illustrate cross-sections of exemplary inclined passes 112 between adjacent levels of the storage arrangement 100 having eight levels for inclination angles 30, 11, and 20 degrees, respectively. One skilled in the art would understand that the present invention may be practiced in a multi-level storage arrangement having any number of levels with inclined passes having any other inclination angles within the scope of the inventive concept. Various transportation support means may be utilized for enabling the robots to move along the passes. For example, rails may be provided along the passes 106, 108, 110 and 112 for supporting movement of robots.

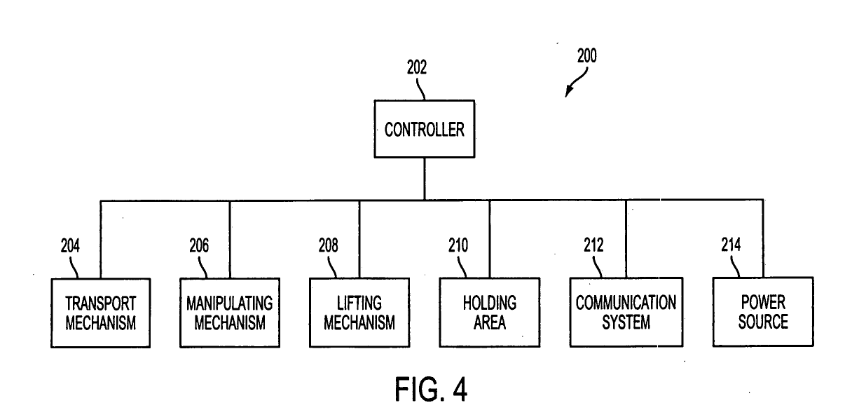

Further, one skilled in the art will understand from this disclosure that the present invention may be practiced with any suitable type of a robot, which may be any autonomous movable device capable of performing its operations automatically or by a remote control. For example, as shown in FIG. 4, a robot 200 may include a controller 202, a transport mechanism 204, a manipulating mechanism 206, a lifting mechanism 208, a holding area 210, a communication system 212 and a power source 214.

The controller 202 may include a processor and a memory for processing and storing various instructions and data required to support operations performed by the robot. The transport mechanism 204 provides mobile capabilities to transport the robot between prescribed points. For example, the transport mechanism may include a carriage for carrying the robot's other parts while the robot performs prescribed operations.

The manipulating mechanism 206 supports robot's operations required handling prescribed objects such as boxes, baskets, cases or other containers for holding goods. For example, the manipulating mechanism may include a mechanical or electromechanical holding element such as a mechanical arm for grabbing, holding and moving prescribed objects. The lifting mechanism 208 provides the robot with ability to move up or down any element of its structure or the entire structure of the robot. For example, the lifting mechanism may include a lifting platform carrying the manipulating mechanism. The lifting platform may be moved up or down to enable the robot to access a storage cell arranged at any location with respect to the floor. Also, the lifting platform may hold a box and/or case being inserted to the storage cell or being removed from the storage cell during prescribed operations.

The holding area 210 enables the robot to hold articles during prescribed operations. For example, the holding area may include one or more box, basket, or any other container or receptacle carried by the robot. The communication system 212 provides the robot with ability to communicate with a control system to receive and acknowledge prescribed instructions. Further, the communication system 212 may enable the robot to input and/or output image and/or sound information. The power source 214 supplies the robot with electrical energy sufficient to perform prescribed operations. For example, the power source 214 may be an electrochemical battery rechargeable using charging devices arranged at prescribed points of the retail facility.

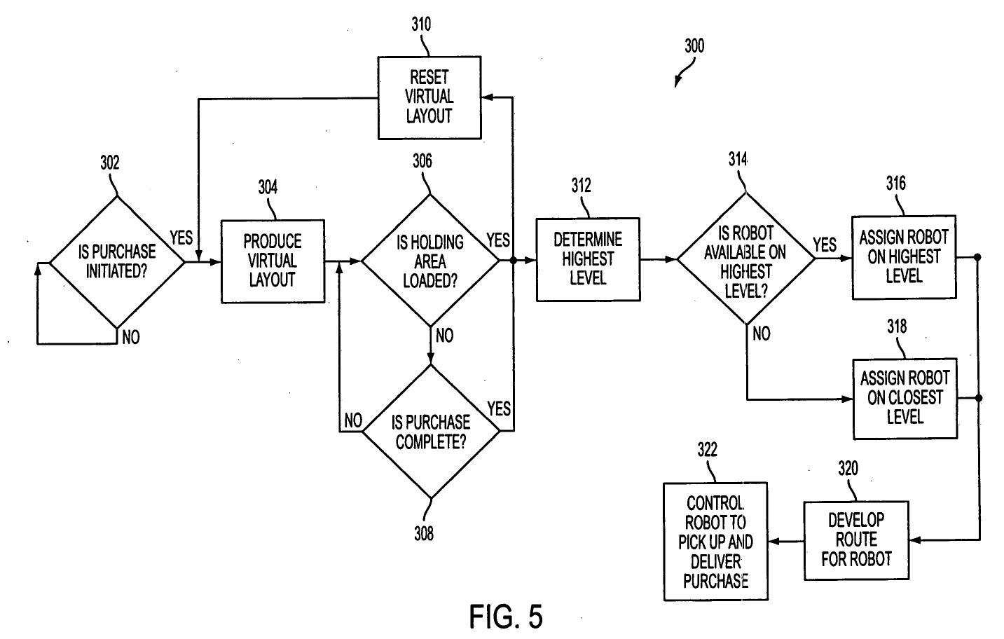

FIG. 5 is a flow chart illustrating operations of a system 300 for controlling robots in the robotic retail facility of the present invention. As one skilled in the art would understand, the control system 300 of the present invention may be implemented in a number of different ways. For example, this system may be implemented using a general purpose digital signal processor provided at the retail facility or remote with respect to the retail facility, and appropriate programming. Alternatively, the control system 300 may be implemented as specifically engineered chips having logic circuits and other components for performing functions described below.

Referring to FIG. 5, the control system 300 determines whether a customer initiates a purchase (step 302). The purchase may be initiated using the purchase ordering terminal 26 arranged at the retail facility 10. Alternatively, the purchase may be initiated using a computer or a telephone device from a location remote with respect to the retail facility 10.

Using a prescribed purchase ordering procedure, the customer may identify particular items that she wants to purchase. In response to a customer's request for a purchase, the control system 300 may operate in an on-the-fly mode for dynamically controlling a robot to pick up an item of the multiple items requested by the customer as soon as the customer requested that item, or in a delayed mode for controlling the robot to pick up the first item of the purchase only after a specific number of the items are requested by the customer. A mode selection mechanism may be provided for selecting a mode of operation.

The on-the-fly mode may be selected, for example, for customers making a purchase order at the retail facility 10 during non-rush hours. In this mode, as soon as a customer identifies each item in her purchase, the control system instructs one of the robots to pick up this item and delivery it to a customer. For example, the control system 300 may determine which robot is available at a location closest to the location where the requested item is stored, and instruct this robot to pick up and deliver the item to a delivery area accessible by the customer. For example, this delivery area may be adjacent the area where the product ordering terminal used by the customer is located. Alternatively, all items of the purchase may be delivered to a predetermined intermediate delivery location, collected together by an available robot and delivered to a delivery area accessible by the customer.

Although the on-the-fly mode of operation makes it possible to quickly serve a small number of customers, the delayed mode of operation is more efficient when a large number of customers must be served at the same time. In the delayed mode of operation, the control system 300 delays instructing a robot or robots to pick up requested items for a particular customer until the customer identifies a certain number of items she wants to include in her purchase, or the purchase is complete.

In accordance with an embodiment of the present invention, when a particular customer identifies items that she wants to purchase, the control system 300 determines whether the holding area 210 of a robot will be sufficiently loaded with the requested items. For example, in step 304, the control system 300 may produce a virtual layout of items being ordered by a particular customer on the holding area 210 of a robot that may be assigned to pick up the purchase. As one skilled in the art of data processing would understand, the virtual layout may be produced electronically by processing data representing the requested items and the holding area.

As discussed above, each item in the retail facility is stored and transported by robots in a case or box of an appropriate size. When a customer identifies an item in her purchase, the control system 300 determines the size of the case or box, in which the requested item is held, and virtually places this case or box on the holding area 210. The control system determines the most efficient layout of cases or boxes on the holding area, for example, the layout which enables a single robot to carry the maximum number of the requested items. Therefore, the order in which cases or boxes representing requested items are virtually placed on the holding area 210 may differ from the order in which the respective items are identified by the customer. The produced virtual layout may represent cases or boxes placed on the holding area 210 in one layer or in several layers depending on particular products being purchased.

To avoid interaction of items that should not be transported together, for example, frozen products such as meat and dry products such as salt, a separate virtual layout may be produced for products stored in each storage section of the storage area 14. As will be discussed in more detail later, separate robots may be assigned for picking up products stored in different storage sections.

In step 306, the control system 300 determines whether the virtual layout indicates that the holding area 210 is fully loaded. The desired degree of loading the holding area may depend on particular products to be picked up and transported. For example, the control system 300 may define a desired spacing between adjacent items at the holding area 210 and produce a virtual layout having the desired spacing.

If in response to a current item ordered by a customer, the virtual layout indicates that the holding area 210 would not be fully loaded with the items that have been ordered so far by that customer, the control system 300 determines whether the currently ordered item is the last item in the purchase ordered by the customer (step 308). If so, the control system 300 resets the virtual layout (step 310) and goes to step 312 to analyze the ordered items.

When in response to the currently ordered item, the virtual layout indicates that the holding area 210 would be fully loaded with the items that have been ordered up to the current moment including the currently ordered item, the control system 300 resets the virtual layout and goes to step 312 to analyze the ordered items. At the same time, the control system 300 returns to step 304 to produce the next virtual layout, if the purchase being made by the present customer is not complete, i.e. the control system 300 determines that the customer orders next items in her purchase. The next virtual layout may represent the layout on the holding area 210 of the next group of the items ordered by the same customer.

In step 312, the control system 300 analyzes the items in the completed virtual layout to determine a sequence in which the ordered items should be picked up, and to determine which robot of the robots currently available in the retail facility may perform that task in the most efficient way. The control system 300 may program robots so as to pick up products in the order depending on their location in the storage area 14 or in a particular storage section of the storage area 14. For example, products stored at a higher level of the storage area or storage section may be picked up before products stored at a lower level. Such a sequence would enable a robot assigned to pick up a group of products to move from a higher level of the storage area or storage section to a lower level. Also, the sequence in which the ordered products should be picked up may be established so as to enable a robot assigned to pick up a group of products to move in a particular direction within one level of the storage area or storage section, for example, from left to right.

Based on the desired sequence for picking up products, the control system 300 defines an initial item among the items virtually placed on the holding area 210. The initial item should be picked up first. For example, the initial item may be a product stored at a level of the storage area or storage section higher than the levels at which the other ordered items are stored. Hence, in step 312, the control system 300 may determine the level, at which the initial item is stored, i.e. the highest level that stores products included in the virtual layout.

In step 314, the control system 300 selects a robot for picking up the ordered items. Any unassigned robot, which does not perform any task assigned by the control system, may be selected. To expedite delivery, the control system 300 may select the unassigned robot that would require the least time to reach the location, at which the initial item is stored. For example, the control system 300 may determine whether an unassigned robot is available on the level, at which the initial item is stored. If yes, the control system 300 assigns that robot to pick up the ordered items (step 316). If several unassigned robots are available at the required level, the control system 300 may assign the robot that would require the smallest amount of time to reach the storage cell, in which the initial item is stored.

If no unassigned robots are available at the storage level, at which the initial item is stored, the control system 300 determines which unassigned robot among robots positioned at different levels would require the smallest amount of time to reach the storage cell, in which the initial item is stored. The control system 300 sends to this robot a request to pick up the ordered products (step 318). To determine the smallest amount of time required for a robot to reach a desired location, the control system 300 may take into consideration various factors enabling the robot to avoid interferences and collisions with other robots.

After a robot is assigned to perform a task of picking up the ordered items, the control system 300 develops for the assigned robot a route from the location, at which the initial item is stored, to an end point of its task (step 320). This route includes storage locations of all items in the virtual layout. The control system 300 may produce an optimal robot's route so as to minimize time required for the robot to pick up all items in the virtual layout. The route may be optimized based on various factors taken into account to avoid interferences and collisions between robots performing different tasks. For example, the control system 300 may minimize waiting periods, during which a given robot is prevented from performing its operations to avoid an interference or collision with another robot.

The end point of the task may be selected based on particular requirements of the task assigned by the control system 300. The end point may be in a delivery zone of the customer's area 12, where the customer waits for her purchase, for example, near the purchase ordering terminal used for ordering the purchase. Alternatively, the end point may be located in a buffer area, where the items picked up by several robots are collected into a single purchase to be delivered to the customer that ordered this purchase.

Separate robot assignment procedures may be performed for different storage sections of the storage area 14. In particular, different storage sections may be served by dedicated robots adapted to suit conditions of particular storage sections. For example, products from the frozen products storage area 20 or the refrigerated products storage area 22 may be picked up by robots adapted for operations in the respective environments. When a customer enters items of her purchase, the control system 300 may identify the items related to specific storage sections, and produce separate virtual layouts for groups of the items related to different storage sections. Based on the virtual layouts, separate robots may be assigned to pick up the items of the same purchase from the respective storage sections.

In step 322, the control system 300 controls the robots to pick up and deliver ordered items from the storage area 14. In particular, the control system 300 sends to a respective robot a task to pick up and deliver requested items. The task may identify the items to be picked up, the layout for arranging the items at the holding area 210 of the robot, the storage cells, where the items are stored; the route from a point, where the robot receives the task, to an initial pick-up location, at which the initial item is stored; and the route from the initial pick-up location to the end point of the task via pick-up locations, at which the other items included in the task are stored.

Various points within the routes may be identified by appropriate coordinates. The pick-up location, at which a respective item is stored, may be associated with address information of a storage cell storing the item. This address information may identify the section and level of the storage area 14, the storage stand 102, and the row and column of the stand, at which the respective item is stored.

Based on the received task, the robot moves to the respective storage cell, and removes the case or box, in which the requested item is held. Then, the robot places the removed case or box on its holding area 210. The cases and boxes may be arranged at the holding area 210 in accordance with the virtual layout developed by the control system 300. One skilled in the art would understand that various robot's manipulations may be utilized for handling cases or boxes to remove them from the respective storage cells and place at the holding area 210.

The longitudinal and transverse passes 106 and 108 may be used by the robots to move within each storage levels, and the vertical and inclined passes 110 and 112 may be utilized for moving between the storage levels. For example, during the performance of the task, the robots may move from an upper level to a lower level until it reaches the end point of the task, which may be in a delivery zone of the customer's area 12, where the customer waits for her purchase, for example, near the purchase ordering terminal used for ordering the purchase. Alternatively, the end point may be located in a buffer area, where the items picked up by several robots are collected into a single purchase to be delivered to the customer that ordered this purchase.

After a robot reaches the end point of the task, it may be released from performing the current task and may receive a next task from the control system 300. If no new task is available, the robot may be moved to a waiting point, where it waits for a new task. The waiting points may be arranged so as to maintain a predetermined distribution of the robots in the storage area 14. The predetermined distribution of the robots may be based on experimental data indicating the frequency of accessing various storage regions during particular periods of day, week and season. The most frequently accessed storage regions store products the most often requested by customers during particular time periods. The number of waiting points in various regions of the storage area 14 may be selected in accordance with an anticipated frequency of access to the respective regions. Therefore, the largest number of robots may be available in or near the most frequently accessed regions storing products the most often requested by customers. Alternatively, the waiting points may be arranged on an upper storage level currently used for storing products.

Hence, the present invention offers a robotic retail facility which makes it possible to satisfy customers' demand without having to maintain a large assortment of products on the shelves. Since the storage area 14 of the present invention is not accessible to customers, it may store substantially more products than the shelves keeping products so as to provide customers with access to these products. As a result, a wide assortment of products may be stored in a limited storage space substantially reducing retailer's cost.

Those skilled in the art will recognize that the present invention admits of a number of modifications, within the spirit and scope of the inventive concepts. For instance, the robotic retail facility and its elements may be implemented in a number of different ways. For example, the control system 300 may be implemented using a general purpose digital signal processor and appropriate programming or specifically engineered chips having logic circuits and other components for performing the functions described above.

While the foregoing has described what are considered to be preferred embodiments of the invention it is understood that various modifications may be made therein and that the invention may be implemented in various forms and embodiments, and that it may be applied in numerous applications, only some of which have been described herein. It is intended by the following claims to claim all such modifications and variations which fall within the true scope of the invention.

1. A robotic system for selling goods at a retail facility, comprising:
a plurality of movable robots, and
a control system responsive to a request for multiple items from a customer for assigning at least one robot of said plurality of the robots to said customer to pick up said multiple items in a storage area not accessible to said customer.

2. The system of claim 1, wherein the control system is configured for controlling said at least one robot to pick up a first item of said multiple items only after a determined number of the items are requested.

3. The system of claim 1, wherein the robot is provided with a holding area for holding the items.

4. The system of claim 3, wherein the control system is configured to determine whether the holding area will be sufficiently loaded with the items being requested by customer, in order to instruct the robot to start picking up the requested items when the holding area will be sufficiently loaded or the number of the requested items is less than the maximum number of items that may be placed at the holding area.

5. The system of claim 3, wherein the control system is configured to virtually place the requested items at the holding area of the robot to produce a virtual layout of the items at the holding area.

6. The system of claim 5, wherein the control system is configured to control the robot to start picking up the items requested by the customer when the virtual layout indicates that the number of items requested by the customer is sufficient to load the holding area of the robot, or the number of the requested items is less than the maximum number of items that may be placed at the holding area.

7. The system of claim 1, wherein the control system is configured to determine an optimal route for the robot to pick up the multiple items requested by the customer.

8. The system of claim 7, wherein the control system is configured to determined the optimal route so as to minimize time required for picking up the multiple items.

9. The system of claim 7, wherein the optimal route is determined to avoid an interference between the robots.

10. The system of claim 1, wherein the control system is configured to assign a task of performing the customer's request to a robot positioned closer to a predetermined storage cell that stores a predetermined item among the multiple items requested by the customer.

11. The system of claim 1, wherein the control system is configured to release the robot assigned to performing the customer's request from the assignment after picking up the multiple requested items, and to position the released robot into a waiting point for receiving a next assignment.

12. The system of claim 11, wherein the control system is configured to select the waiting point so as maintain a predetermined distribution of the robots in the storage area.

13. The system of claim 12, wherein the predetermined distribution of the robots in various regions of the storage area is maintained in accordance with an anticipated frequency of robot's access to the respective regions.

14. The system of claim 1, wherein the control system is configured to control the robot to deliver the multiple requested items to the customer.

15. The system of claim 1, wherein the control system comprises a mode selection mechanism for selecting between an on-the-fly mode for dynamically controlling the robot to pick up an item of the multiple items requested by the customer as soon as the customer requested that item, and a delayed mode for controlling the robot to pick up a first item after a determined number of the items are requested.

16. A robotic system for selling goods, comprising:
a storage area including a first storage section and a second storage section separate from said first storage section,
a plurality of movable robots including at least one first robot assigned to said first storage section and at least one second robot assigned to said second storage section, and
a control system responsive to a request from a customer for multiple items, including at least one first item stored in said first storage section and at least one second item stored in said second storage section, for controlling said first robot assigned to said first storage section to pick up said first item and for controlling said second robot assigned to said second storage section to pick up said second item.

17. The system of claim 16, wherein said first and second storage sections are provided for storing different types of goods.

18. The system of claim 16, wherein said first and second storage sections provide different conditions for storing goods.

19. A robotic system for selling goods at a retail facility, comprising:
a storage structure having a plurality of storage levels for storing goods, and
a plurality of movable robots, each controlled to pick up at the storage structure multiple items requested by a customer,
wherein said storage structure has first passes for providing the robots with access to the stored goods within each level of said plurality of levels, and second passes for enabling the robots to move between the levels.

20. The system of claim 19, wherein the second passes include at least one inclined pass for enabling the robots to move from an upper level to a lower level of said structure.

21. The robotic system of claim 19, wherein the second passes include at least one substantially vertical pass for enabling the robots to move between the levels of said structure.

22. The robotic system of claim 21, further comprising at least one lifting device for moving the robots through the substantially vertical pass between the levels of said structure.

23. The robotic system of claim 19, further comprising rails for supporting movement of the robots within each level.

24. The robotic system of claim 19, further comprising a control system configured to control the robots to pick up the requested items.

25. The robotic system of claim 24, wherein the control system is responsive to a request from the customer for an item stored on a predetermined level of said plurality of levels, by assigning a robot available on the predetermined level to pick up the item.

26. The system of claim 25, wherein the control system is configured to assign an available robot located on a level closest to the predetermined level, if no robots are available on the predetermined level.

27. The system of claim 19, wherein the control system is configured to determine the highest storage level that stores an item of the multiple requested items.

28. The system of claim 27, wherein the control system is configured for assigning a robot available on said highest storage level to pick up the multiple requested items.

29. The system of claim 28, wherein the control system is configured for controlling an available robot to move to said highest level for picking up the multiple items in the requested purchase, if no robots are available on said highest level.

30. The system of claim 19, wherein the control system is configured for controlling a robot assigned to pick up the multiple requested items to move from a higher level of said structure to a lower level of said structure during collection of the requested items.

31. The system of claim 23, wherein the control system is configured to maintain a predetermined distribution of the robots in the storage structure.

32. The system of claim 19, wherein the system comprises at least one charging device for recharging power sources of the robots.
